(19) United States
(12) Patent Application Publication
(10) Pub. No.: US 2018/0039771 A1
(43) Pub. Date: Feb. 8, 2018

(54) METHOD OF AND SERVER FOR AUTHORIZING EXECUTION OF AN APPLICATION ON AN ELECTRONIC DEVICE

(71) Applicant: YANDEX EUROPE AG, Luzern (CH)

(72) Inventors: Sergey Sergeevich KONSTANTINOV, Moscow (RU); Fedor Anatolievich GOLUBEV, Magnitogorsk (RU)

(21) Appl. No.: 15/607,574

(22) Filed: May 29, 2017

(30) Foreign Application Priority Data
Aug. 5, 2016 (RU) 2016132426

(51) Int. Cl. G06F 21/33; H04W 12/06; G06F 21/12

(52) U.S. Cl. CPC G06F 21/335; G06F 21/121; H04W 12/06; G06F 2221/0711

(57) ABSTRACT

There is discloses a method for authorizing execution of an application on an electronic device, the electronic device being connectable to a server via a communication network, the electronic device being associated with a device-execution environment. The method is executable at a server and comprises: receiving a request from the electronic device to authorize the electronic device for executing the application, the request including user credentials; generating a request for validating the device-execution environment associated with the electronic device, the request including a computer-executable code, the computer-executable code configured to solicit an execution output unique to the device-execution environment; transmitting the request for validating the device-execution environment to the electronic device; receiving, from the electronic device, the execution output generated by the computer-executable code; in response to the execution output matching a pre-determined expected execution output, authorizing the execution of the application.

### CROSS-REFERENCE

The present application claims priority to Russian Patent Application No. 2016132426, filed Aug. 5, 2016, entitled “Method Of And Server For Authorizing Execution Of An Application On An Electronic Device,” the entirety of which is incorporated herein.

### FIELD

The present technology relates to electronic device authentication in general and, more specifically, to a method of and a server for authorizing execution of an application on an electronic device.

### BACKGROUND

In today's computer technologies, several user/device authorization schemes are known. Broadly speaking, a given authentication scheme aims to verify the identity of a user or a device attempting to access a local or a network resource. For example, it is known to authenticate a user of a computer device by requesting log in credentials from the user. The log in credentials can be provided in a form of a username-password combination, biometric data (a fingerprint, a voice print, or the like), a machine-readable token, a digital certificate, and the like. It is also known to authenticate a user attempting to access a network resource or a network service by providing user-authentication credentials (again, in the form of a username-password combination, a digital certificate, an answer to a challenge questions, and the like). Irrespective of why the user is being authenticated (i.e. to access a local device or a remote network resource), the provided user credentials are verified against pre-stored authorized credentials and, depending on the outcome of the comparison, the user is either granted or is denied access to the requested device or resource.

It is also known to authenticate application(s) for use on client devices. For example, when a given user downloads (or otherwise obtains—on a computer readable medium or the like) an application, which use is governed by a license, the user typically needs to authenticate the version of the application. This authentication is typically done by the user inputting a unique application key. The unique application key is typically provided to the user as part of the shrink-wrap license (in case of the application being purchased on the computer readable medium) or as part of a purchase validation receipt (in case the application is downloaded online). During the installation process, the user inputs the unique application key, which is validated against a network database of unique application keys to ensure that the user has indeed purchased a license for the use of the application.

U.S. Pat. No. 8,332,647 discloses a system and method for dynamic, multi-attribute authentication. In a particular embodiment, a method for authentication includes receiving, at an authentication web server, an authentication request comprising a workstation message and a user message, wherein the workstation message comprises a workstation object and a workstation signature, the workstation object comprises a workstation certificate associated with a workstation, the user message comprises a user object and a user signature, and the user object comprises a copy of the workstation message and a user certificate associated with a user of the workstation. The method further includes verifying the workstation signature and user signature, validating the workstation certificate and the user certificate, retrieving one or more caveats associated with the workstation and one or more caveats associated with the user, and determining one or more caveats associated with both the workstation and the user.

U.S. Pat. No. 8,756,661 discloses a dynamic authentication system that makes authentication stronger, while reducing the cost to business and the burden to users. The system includes a service that provides centralized, non-federated, proxied authentication. The system uses a two-pass authentication process that first receives a supposed identity of the user and then determines one or more authentication criteria for proving that supposed identity. When the user attempts to use an online service that relies on the dynamic authentication system for authentication, the service requests the users identity. The system dynamically determines authentication criteria for the user to prove the provided identity belongs to the user. In the second pass, the service receives a response from the user containing additional authentication information, and forwards the received response to the system for verification. If verification succeeds, the service allows the user to access the requested resources.

U.S. Pat. No. 8,959,659 discloses a software authorization system that has a server end and a user end. A software authorization method includes acquiring a software identification code of a protected software when the user end downloads the protected software from the server end; transmitting the software identification code and an inherent user identification code to the server end; acquiring a first key and main key by the server end according to the user identification code and the software identification code, respectively, so as to generate a second key by operating the main key and the first key and transmit the second key to the user end; restoring the main key by the user end with the second key combined with the first key; and decrypting the protected software by the main key. Therefore, the protected software is hard to be decrypted.

### SUMMARY

Developers of the present technology have appreciated at least one technical problem associated with the prior art approaches to authorizing access to a resource or authenticating execution of an application. More specifically, developers of the present technology have appreciated that it may be beneficial to not only authenticate the user/device attempting to access a resource or attempting to authorize execution of an application, but also authorize the device-execution environment from which authorization request is generated.

Broadly speaking, embodiments of the present technology are directed to methods and systems for validating that the electronic device attempting to execute an application or to access a network resource is authorized to execute the application or to access the network resource (as the case may be). Embodiments of the present technology contemplate authentication by means of user credentials, as well as validation of the device-execution environment associated with the electronic device attempting to execute the application or to access the network resource. The validation of the device-execution environment is executed by provisioning (by an authentication server or the like) a computer-executable code that is configured to solicit a pre-determined execution output from the electronic device being authenticated, the pre-determined execution output being unique to the device-execution environment of the electronic device attempting to execute an application or to access the network resource.

Some embodiments of the present technology are directed to authorizing an electronic device accessing a server (for accessing a web resource, for downloading data, and the like). The authorization of the electronic device is executed by validating a pair of tokens—a static token and a dynamic token. The static token and the dynamic token can be provisioned during an electronic device authentication provisioning routine.

The static token is configured to authorize a user of the electronic device or the electronic device itself and may comprise user credentials (any combination of known user credential implementations). The dynamic token includes a computer executable code that is configured to solicit an execution response that is unique to the device-execution environment associated with the electronic device that is being authenticated. The computer executable code can be generated and incorporated into the dynamic token when the dynamic token is first generated. Alternatively, the computer executable code can be dynamically generated by the authentication server (for example, the computer executable code can be generated in real-time, every time the electronic device requests authorization from the authorization server, which can be the same server as the one hosting the network resource that the electronic device is trying to access).

In some embodiments of the present technology, the authentication server generates the computer executable code after receiving and validating the static token from the electronic device (as part or after of the access request). In other embodiments, the authentication server generates the computer executable code after receiving the static token from the electronic device, the generation of the computer executable code being based (at least partially) on the information contained in the static token data. For example, the authentication server may generate the computer executable code using the data of the static token as input for a function of the computer executable code.

In response to the electronic device receiving the so-generated computer executable code (or a trigger to execute the computer executable code that has been pre-populated into the dynamic token), the electronic device executes the computer executable code to generate an execution output. The authentication server compares the so-generated execution output to a pre-defined expected execution output (recalling that the so-generated computer executable code is configured to solicit an execution output unique to the device-execution environment associated with the electronic device being authenticated). If the received execution output matches the pre-defined execution output that is unique to the device-execution environment, the dynamic token is considered validated. In response to both the static token and the dynamic token being validated, the authentication server authenticates the electronic device and permits accessing the network resource (or, more broadly, execution of the application).

In a particular implementation, the network resource being accessed may be a Yandex.Maps™ Application Programming Interface (API) for accessing map data for incorporation thereof into another network resource (such as, for example, a corporate web site, etc.), the other network resource being referred to herein below as a destination network resource. To that end, the destination network resource is provisioned with an API code in order to download map data for rendering a map within the destination network resource, when displayed on a requesting client device. During provisioning of the API code, the electronic device associated with the destination network resource (such as a server hosting the network resource) is provisioned with the static token (containing, for example, the ID and password) and the dynamic token. The dynamic token contains a computer executable code (or, alternatively, the computer executable code can be sent to the dynamic token during the actual authentication routine), the computer executable code being configured to solicit an execution output that is unique to the device-execution environment specific to the electronic device. For example, the computer executable code can be configured to solicit the execution output that is unique to an Operating System (OS) and/or specific web browser associated with the electronic device.

For example, the computer executable code can be configured to solicit an execution output that is unique to the device-execution environment that is: Linux-based OS and the Firefox™. Within these examples, the computer executable code will include commands that can be executed within this given device-execution environment, but would return wrong or absent result in a different device-execution environment (such as the same browser executed in the Windows™ Server OS).

During the authentication routine, the authentication server or the server hosting the network resource validates the static token and the dynamic token associated with the electronic device hosting the network resource to which the requesting electronic device requests permissions to access. In response to both the static token and the dynamic token being validated, the requesting electronic device is allowed to access the network resource (i.e. as an example, to download map data for incorporation into the destination network resource).

As such, in accordance with a first broad aspect of the present technology, there is provided a method for authorizing execution of an application on an electronic device, the electronic device being connectable to a server via a communication network, the electronic device being associated with a device-execution environment, the method executable at a server. The method comprises: transmitting to the electronic device a static token and a dynamic token, the static token including user credentials to authorize the electronic device; and the dynamic token to authorize the device-execution environment; receiving a request from the electronic device to authorize the electronic device for executing the application, the request including user credentials associated with the electronic device; transmitting to the electronic device a request for validation of the static token by requesting user credentials from the electronic device; validating the static token by receiving and verifying user credentials; transmitting to the electronic device a request for validation of the dynamic token, the request including a computer-executable code, the computer-executable code configured to solicit an execution output unique to the device-execution environment; the execution output matching a pre-determined expected output validating the dynamic token; validating the dynamic token by validating the execution output to the pre-determined expected output; and in response to both the static token and the dynamic token having been validated, authorizing the electronic device to execute the application.

In some implementations of the method, the method further comprises transmitting an execution trigger to the electronic device, the execution trigger for triggering execution of the application by the electronic device.

In some implementations of the method, the device-execution environment comprises at least one of: a hardware parameter, an operating system parameter, and a software parameter and wherein the execution output is unique to at least one of the hardware parameter, the operating system parameter, and the software parameter.

In some implementations of the method, the execution output is unique to all of the hardware parameter, the operating system parameter, and the software parameter.

In some implementations of the method, the method further comprises generating the computer executable code.

In some implementations of the method, the generating the computer executable code comprises selecting a sub-set of computer-executable instructions from a set of computer-executable instructions, the set of computer-executable instructions having been pre-selected for the device-execution environment.

In some implementations of the method, the generating the computer executable code is done before transmitting to the electronic device the static token and the dynamic token.

In some implementations of the method, the method further comprises embedding the computer executable code into the dynamic token.

In some implementations of the method, the generating the computer executable code is done in response to one of: the receiving the request to authorize the electronic device for executing the application and the validating of the static token.

In some implementations of the method, the generating the computer executable code is based at least in part on the static token.

In some implementations of the method, the generating the computer-executable code comprises selecting at least two sub-sets of computer-executable instructions from a set of computer-executable instructions, the set of computer-executable instructions having been pre-selected for the device-execution environment, each of the at least two sub-sets of computer-executable instructions for authorizing a particular execution portion of the application.

In some implementations of the method, the application is a web-session based application that requires API data downloadable from the server.

In accordance with another broad aspect of the present technology there is provided a method for authorizing execution of an application on an electronic device, the electronic device being connectable to a server via a communication network, the electronic device being associated with a device-execution environment. The method is executable at a server. The method comprises: receiving a request from the electronic device to authorize the electronic device for executing the application, the request including user credentials associated with the electronic device; in response to positive validation of the user credentials: generating a request for validating the device-execution environment associated with the electronic device, the request including a computer-executable code, the computer-executable code configured to solicit an execution output unique to the device-execution environment; transmitting the request for validating the device-execution environment to the electronic device; receiving, from the electronic device, the execution output generated by the computer-executable code; in response to the execution output matching a pre-determined expected execution output, authorizing the electronic device to execute the application.

In some embodiments of the method, the method further comprises transmitting an execution trigger to the electronic device, the execution trigger for triggering execution of the application by the electronic device.

In some implementations of the method, the device-execution environment comprises at least one of: a hardware parameter, an operating system parameter, and a software parameter and wherein the execution output is unique to at least one of the hardware parameter, the operating system parameter, and the software parameter.

In some implementations of the method, the execution output is unique to all of the hardware parameter, the operating system parameter, and the software parameter.

In some implementations of the method, the method further comprises generating the computer executable code.

In some implementations of the method, the generating the computer executable code comprises selecting a sub-set of computer-executable instructions from a set of computer-executable instructions, the set of computer-executable instructions having been pre-selected for the device-execution environment.

In some implementations of the method, the generating the computer executable code is done before the receiving the request to authorize the electronic device for executing the application.

In some implementations of the method, the generating the computer executable code is done in response to one of: the receiving the request to authorize the electronic device for executing the application and the positive validation of the user credentials.

In some implementations of the method, the generating the computer executable code is based at least in part on the user credentials.

In some implementations of the method, the generating the computer-executable code comprises selecting at least two sub-sets of computer-executable instructions from a set of computer-executable instructions, the set of computer-executable instructions having been pre-selected for the device-execution environment, each of the at least two sub-sets of computer-executable instructions for authorizing a particular execution portion of the application.

In some implementations of the method, the application is a web-session based application that requires API data downloadable from the server.

In the context of the present specification, a “server” is a computer program that is running on appropriate hardware and is capable of receiving requests (e.g. from electronic devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. Thus, some (non-limiting) examples of electronic devices include personal computers (desktops, laptops, netbooks, etc.), smartphones, and tablets, as well as network equipment such as routers, switches, and gateways. It should be noted that a device acting as an electronic device in the present context is not precluded from acting as a server to other electronic devices. The use of the expression “a electronic device” does not preclude multiple electronic devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “relevance factor of the search query result set” shall mean the likelihood that the user submitting the search query was intending to see data maintained within the search query result set.

In the context of the present specification, the expression “component” is meant to include software (appropriate to a particular hardware context) that is both necessary and sufficient to achieve the specific function(s) being referenced.

In the context of the present specification, the expression a “search query result set” is a listing of results returned by a search engine, which may encompass one or more general or specialized search modules, in response to a search query. Search query result set may contain a listing of results returned by a web search module, or by one or more vertical search modules, or by combination of results returned by web module and one or more vertical modules. The search query result set may also contain no results.

In the context of the present specification, the expression a “search engine result page” is a listing of results to be displayed to a client on an electronic device, the listing generated by combining a search query result set with targeted messages.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a diagram of a system implemented in accordance with non-limiting embodiments of the present technology.

FIG. 2 depicts a non-limiting embodiment of a computer screen (which can be coupled to an electronic device of the system of FIG. 1 or be part of the electronic device of the system of FIG. 1), the computer screen displays a rendered page.

FIG. 3 depicts a non-limiting embodiment of an authentication data table maintained by a network resource server of the system of FIG. 1.

FIG. 4 depicts a block diagram of a method, the method being implemented in accordance with non-limiting embodiments of the present technology, the method executable within the system of FIG. 1.

FIG. 5 depicts a block diagram of a method, the method being implemented in accordance with other non-limiting embodiments of the present technology, the method executable within the system of FIG. 1.

### DETAILED DESCRIPTION

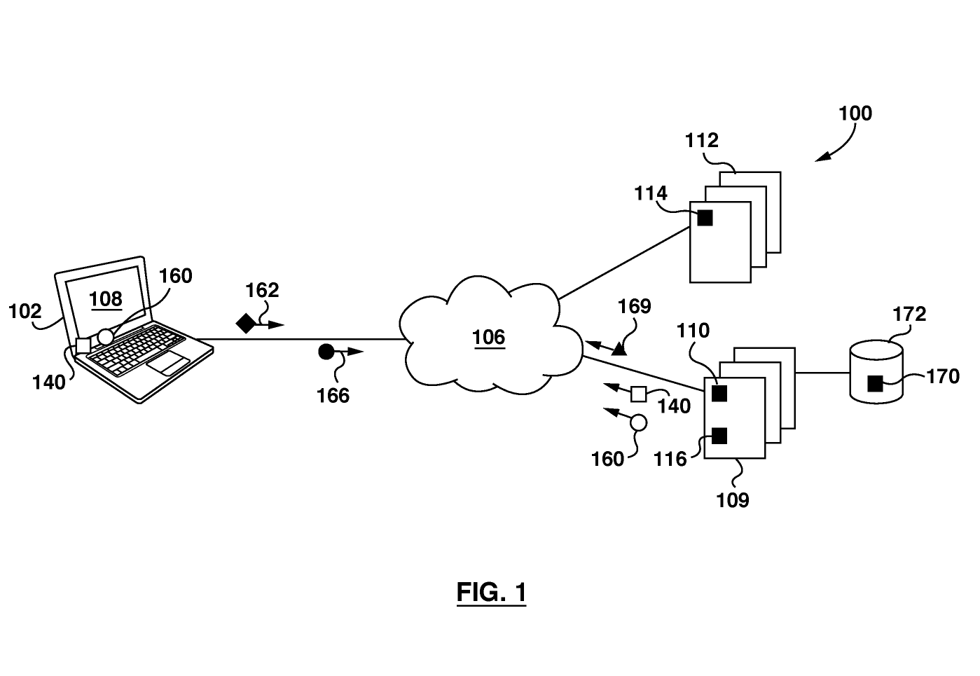

FIG. 1 illustrates a system 100 in accordance with one implementation of the present technology. It is to be expressly understood that the system 100 is merely one possible implementation of the present technology. Thus, the description thereof that follows is intended to be only a description of illustrative examples of the present technology. This description is not intended to define the scope or set forth the bounds of the present technology. In some cases, what are believed to be helpful examples of modifications to system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances a simple implementation of the present technology, and that where such is the case they have been presented in this manner as an aid to understanding. As persons skilled in the art would understand, various implementations of the present technology may be of a greater complexity.

The system 100 comprises an electronic device 102. The electronic device 102 is typically associated with a user (not depicted) and, as such, can sometimes be referred to as a “client device”. It should be noted that the fact that the electronic device 102 is associated with the user does not need to suggest or imply any mode of operation—such as a need to log in, a need to be registered or the like. Naturally, the system 100 can have a plurality of electronic devices similar to or different from the electronic device 102.

The implementation of the electronic device 102 is not particularly limited, but as an example, the electronic device 102 may be implemented as a personal computer (desktops, laptops, netbooks, etc.), a wireless electronic device (a cell phone, a smartphone, a tablet and the like), as well as network equipment (a router, a switch, or a gateway). The general implementation of the electronic device 102 is known in the art and, as such, will not be described here at much length. Suffice it to say that the electronic device 102 comprises a user input interface (such as a keyboard, a mouse, a touch pad, a touch screen and the like) for receiving user inputs; a user output interface (such as a screen, a touch screen, a printer and the like) for providing visual or audible outputs to the user; a network communication interface (such as a modem, a network card and the like) for two-way communication over a communication network 106; and a processor coupled to the user input interface, the user output interface and the network communication interface, the processor being configured to execute various routines, including those described herein below. To that end the processor may store or have access to computer readable commands which commands, when executed, cause the processor to execute the various routines described herein.

The above-mentioned communication network 106 can be implemented as the Internet. In other embodiments of the present technology, the communication network 106 can be implemented differently, such as any wide-area communication network, local-area communication network, a private communication network and the like.

The electronic device 102 comprises hardware and/or software and/or firmware (or combinations thereof) that enable the electronic device 102 to execute an application 108. The application 108 can be a browser application, which is configured to enable the user to access one or more network resources via the communication network 106, such as a network resource 110 hosted by a network resource server 109. Alternatively, the application 108 can be a map application, a game application, a document-processing application, a specialized software application, and the like.

The network resource server 109 is coupled to the communication network 106 via a communication link (not separately numbered). The network resource server 109 can be implemented as a conventional computer server. In an example of an embodiment of the present technology, the network resource server 109 can be implemented as a Dell™PowerEdge™ Server running the Microsoft™ Windows Server™ operating system. Needless to say, the network resource server 109 can be implemented in any other suitable hardware and/or software and/or firmware or a combination thereof. In the depicted non-limiting embodiment of present technology, the network resource server 109 is a single server. In alternative non-limiting embodiments of the present technology, the functionality of the network resource server 109 may be distributed and may be implemented via multiple servers.

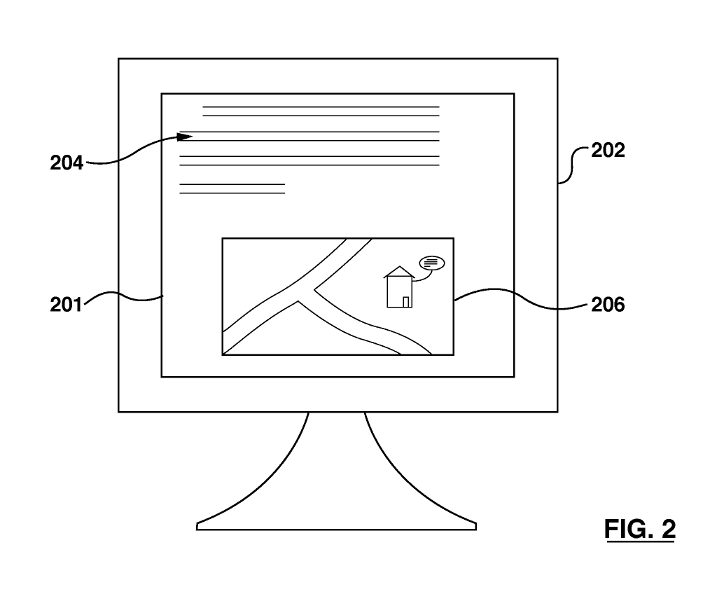

The implementation of the network resource server 109 is well known. However, briefly speaking, the network resource server 109 comprises a communication interface (not depicted) structured and configured to communicate with various entities (such as the electronic device 102, for example and other devices potentially coupled to the communication network 106) via the communication network 106. The network resource server 109 further comprises at least one computer processor (not depicted) operationally connected with the communication interface and structured and configured to execute various processes to be described herein. The network resource server 109 is configured to provide access to a plurality of network resources, one of which, the network resource 110 is depicted in FIG. 2.

In some embodiments of the present technology, the network resource 110 can be a map comprising geo-location information of various objects. In some embodiments of the present technology, the network resource server 109 can generate the map as a static map for downloading into the electronic device 102 (the static map being generated, for example, with a particular coordinate and a particular viewport, as requested by the electronic device 102). Alternatively, the network resource server 109 can generate the map as an interactive map for downloading into the electronic device 102 (the interactive map being associated with a particular coordinate and a particular viewport, as requested by the electronic device 102). The user of the electronic device 102 can interact with the interactive map, for example, by executing a “mouse-over” action over a particular object of the interactive map to obtain additional information associated with the particular objects (such as, opening hours information, an average bill information, other clients' rating information, and the like).

In alternative embodiments of the present technology, the network resource server 109 can generate the map as a downloadable map for incorporating the map into a destination network resource 114 hosted by another network resource server 112. It is noted that the other network resource server 112 can be (but does not have to be) implemented substantially similar to the network resource server 109.

For example, the network resource server 109 can generate the downloadable map as the JAVASCRIPT™ map for downloading via an Application Programming Interface (API) 116 hosted by the network resource server 109. Depending on the particular implementation, the downloadable map can include one or more of: map tiles for rendering a particular map section (based on coordinates, requested viewport and the requested zoom level), interactive map elements for generating one or more interactive map elements associated with the objects depicted in the map view, API data for requesting information via the API 116 and/or for rendering the received downloadable map data by the electronic device 102.

An example of incorporation of the interactive map, as rendered by the electronic device, is depicted with reference to FIG. 2, which FIG. 2 depicts a non-limiting embodiment of a computer screen 202 (which can be coupled to the electronic device 102 or be part of the electronic device 102, or be coupled to or be part of another electronic device, not depicted in FIG. 1, but which other electronic device may require downloading the destination network resource 114 with the map data from the network resource 110 being incorporate therein). The computer screen 202 displays a rendered page 201. The rendered page includes (i) a first portion 204, the first portion 204 generated using information received from the destination network resource 114, and (ii) a second portion 206, the second portion 206 generated using information received from the network resource 110.

As an example of the above implementation, the rendered page 201 can be a home page of a manufacturing facility, the first portion 204 presenting information about the manufacturing facility, while the second portion 206 providing a map of how to reach the manufacturing facility. Rather than having to code the map information themselves, the web master of the rendered page 201 may instead download the map information provided by the network resource server 109, via the network resource 110 and the API 116.

Within some of these embodiments of the present technology, let's assume that the electronic device 102 requires downloading the destination network resource 114 with the map information embedded there in. To that end, the electronic device access, at a network address or another identifier associated with the destination network resource 114, the destination network resource 114. The destination network resource 114, downloaded by the application 108, contains API resources for accessing the map information via the API 116 from the network resource 110. In some embodiments of the present technology, in order to download the map information via the API 116, the electronic device 102 (or the application 108 executed on the electronic device 102 or both) needs to be authenticated with the network resource server 109. In some embodiments of the present technology, the data required for authentication with the network resource server 109 is provisioned during execution of a service provisioning routine (will be described below).

The application 108 can be said to be associated with a device-execution environment specific to the electronic device 102. In some embodiments of the present technology, the device-execution environment includes hardware parameters of the electronic device 102. In other embodiments of the present technology, the device-execution environment includes operating system parameters of the electronic device 102. In yet additional embodiments, the device-execution environment includes software parameters associated with the application 108 executed by the electronic device 102 (such as, for example, a version of the application 108, a vendor associated with the application 108, and the like). In yet additional embodiments of the present technology, the device-execution environment includes a combination of some or all of these (or different) of: the hardware parameters, the operating system parameters, and the software parameters.

It is noted that for the purposes of the description to be presented below, the network resource server 109 will be considered as the “authentication server”—i.e. the server that authorizes the electronic device 102 to access the network resource 110 (as an example of an authorization to execute an application, such as the application 108). However, it should be appreciated that the authentication process can be executed by a separate server (not depicted), i.e. a server dedicated to the authentication process, which server can be different from the network resource server 109 that hosts the network resource 110 being accessed.

Authentication Provisioning Routine

The network resource server 109, during the authentication provisioning routine of the electronic device 102, generates two tokens for the electronic device 102—a static token 140 and a dynamic token 160. As alluded to above, the static token 140 is configured to authorize a user of the electronic device 102 or the electronic device 102 itself. To that end, the static token 140 may include any suitable user credentials (any combination of known user credential implementations can be used, such as but not limited to: username-password combination, biometric data (a fingerprint, a voice print, or the like), a machine-readable token, a digital certificate, and the like).

The dynamic token 160 is configured to validate the device-execution environment associated with the electronic device 102. In some embodiments of the present technology, the dynamic token 160 includes a computer executable code that is configured to solicit execution response that is unique to the device-execution environment associated with the electronic device that is being authenticated. Within these embodiments, the network resource server 109 generates the computer executable code and embeds it into the dynamic token 160.

In alternative embodiments of the present technology, the network resource server 109 can generate the computer executable code dynamically (for example, the computer executable code can be generated in real-time, every time the electronic device 102 requests authorization from the network resource server 109).

In some embodiments of the present technology, the network resource server 109 can generate the computer executable code based at least partially on the content of the static token 140. In those embodiments of the present technology, where the network resource server 109 generates the computer executable code at the authentication provisioning routine, the network resource server 109 generates the computer executable code based (at least partially) on the information contained in the static token 140 data. For example, the network resource server 109 may generate the computer executable code using the data of the static token 140 as input for a function of the computer executable code.

In those embodiments of the present technology, where the network resource server 109 generates the computer executable code in real time (i.e. when the authentication is performed), the dynamic token 160 contains an “envelope” for executing the computer executable code at a later stage, when the network resource server 109 generates and transmits such computer executable code to the electronic device 102.

In these embodiments of the present technology, the network resource server 109 can generate the computer executable code during the actual authentication routine, i.e. after the network resource server 109 receives an authentication request (for example in the form of an access request) and after the network resource server 109 receives the static token 104 from the electronic device 102 (as part or after the access request). In yet other embodiments, the network resource server 109 generates the computer executable code after receiving the static token 140 from the electronic device 102, the generation of the computer executable code being based (at least partially) on the information contained in the static token 140 data. For example, the network resource server 109 may generate the computer executable code using the data of the static token 140 as input for a function of the computer executable code.

The network resource server 109 then transmits the static token 140 and the dynamic token 160 to the electronic device (depicted in FIG. 1). The electronic device 102 stores the static token 140 and the dynamic token 160 in an internal memory thereof.

As part of the authentication provisioning routine, the network resource server 109 generates (or updates, as the case may be) an authentication data table 170 and stores the authentication data table 170 in a database 172.

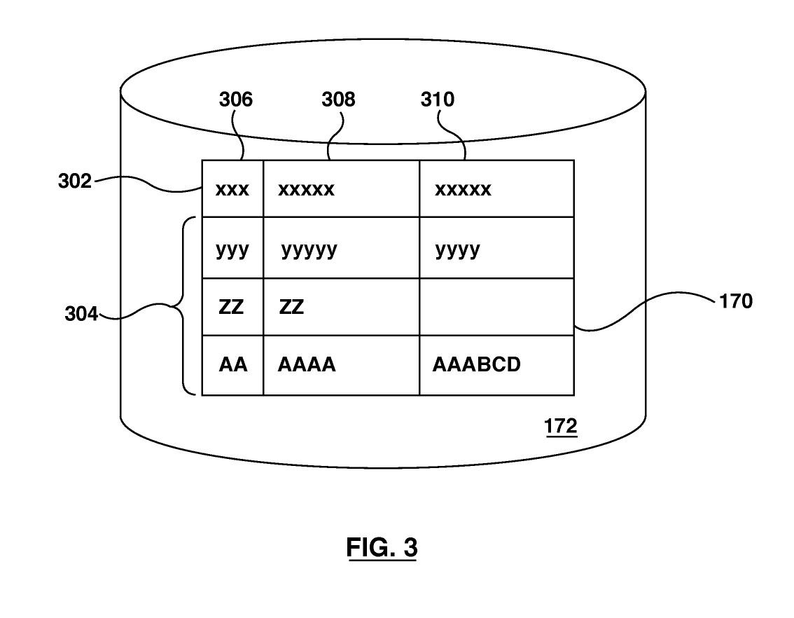

With reference to FIG. 3, there is depicted a non-limiting embodiment of the authentication data table 170 maintained by the network resource server 109 in the database 172.

The authentication data table 170 includes multiple entries, generated during the execution of various authentication provisioning routines, the multiple entries including a first entry 302 associated (as an example) with the electronic device 102 and a plurality of additional entries 304 associated with other electronic device (not depicted) potentially present within the system 100.

A given record of the authentication data table 170, such as the example of the first entry 302 maps a unique device identifier 306 associated in this case with the electronic device 102, an indication of the device-execution environment 308 associated in this case with the electronic device 102, and an indication of authentication credentials 310 associated in this case with the electronic device 102.

Within various embodiments of the present technology, the unique device identifier 306 can be implemented as media access control address (MAC address), a static IP address, or any other suitable device identifier associated with the electronic device 102.

Within various embodiments of the present technology, the indication of the device-execution environment 308 can contain hardware parameters of the electronic device 102. In other embodiments of the present technology, the indication of the device-execution environment 308 includes operating system parameters of the electronic device 102. In yet additional embodiments, the indication of the device-execution environment 308 includes software parameters associated with the application 108 executed by the electronic device 102 (such as, for example, a version of the application 108, a vendor associated with the application 108, and the like). In yet additional embodiments of the present technology, the indication of the device-execution environment 308 contains one or more of the operating system parameters, the hardware parameters, and the software parameters associated with the electronic device 102.

The indication of the device-execution environment 308 is obtained from the electronic device 102 during the authentication provisioning routine and is used, at least in part, for generation of the above-mentioned dynamic token 160. More specifically, the indication of the device-execution environment 308 can be used for generation of the above-mentioned computer executable code. To that end, the indication of the device-execution environment 308 includes an indication of the pre-determined execution output expected in response to the above-mentioned computer executable code. The indication of the pre-determined execution output can be stored (and updated) in the indication of the device-execution environment 308 every time a new version of the computer executable code is generated.

Within various embodiments of the present technology, the indication of authentication credentials 310 contains the log in credentials provisioned for the electronic device 102. The log in credentials can be provided in a form of a username-password combination, biometric data (a fingerprint, a voice print, or the like), a machine-readable token, a digital certificate, and the like. The indication of the authentication credentials can be used for verifying the static token 140 associated with the electronic device 102.

Generating of the Computer Executable Code Routine

As has been mentioned above, the computer executable code generated by the network resource server 109 is configured to solicit an execution output that is unique to the device-execution environment associated with the electronic device 102. Broadly speaking, the execution output generated by the computer executable code is configured to identify the device-execution environment associated with the electronic device 102 with enough specificity for the network resource server 109 to be able to identify that the device-execution environment of the electronic device 102 so identified is the one that has been authorized to use the network resource 110.

For the avoidance of doubt, the term “unique” does not imply, within the meaning of the present description, that one other electronic device (not depicted) potentially present within the system 100 can not generate the same execution output. On the contrary, it is possible that one or more other electronic devices (not depicted) potentially present within the system 100 having the same device-execution environment and in response to the receiving of the same computer executable code can generate the same execution output. Hence, within the meaning of the present description, the term “uniquely identify” is meant to connote uniquely identifying the device-execution environment of the electronic device 102 that has been authorized for accessing the network resource 110, as opposed to another device-execution environment that has not been authorized to access the network resource 110.

How such computer executable code is generated is not particularly limited and below are just a few examples for implementing the computer executable code that solicits a particular execution output unique to the device-execution environment of the electronic device 102.

OS Specific Commands:

Linux™ and Unix™—Based Operating Systems

SUDO (“superuser do”) is a type of computer executable commands that allows a user with proper permissions to execute a command as another user, such as the super-user (full access or simply administrator permissions). As an example, this type of computer executable commands can be used for executing specific functions, e.g. calling another application from a first application.

SUDO commands examples:

sudo −u comphope is /home/comphope/hope

Lists the contents of the /home/comphope/hope directory as the comphope user.

sudo −v

Extend/reset sudo's automatic authentication timeout, allowing you to continue issuing sudo commands without entering a password.

Windows™ Based Operating System:

RUNAS (= [symbol] Run as [symbol] ) similar to SUDO in Linux\Unix-based OSs

Allows a user to run specific tools and programs with different permissions than the user's current log in provides.

runas [{/profile\/noprofile}] [/env] [/netonly] [/smartcard] [/showtrustlevels] [/trustlevel] /user: UserAccountName program

Examples of RUNAS type computer executable commands

To start an instance of the command prompt as an administrator on the local computer:

runas /user: localmachinename\administrator cmd

Application Specific Commands:

In alternative embodiments of the present technology, the pre-determined execution output can be indication of the operating system executed by the electronic device 102. Alternatively, the pre-determined execution output can be detection of the version of the browser (such as my means of executing a JavaScript™ or the like).

function get_name_browser( ){

In response to such the computer executable code, the execution output is obtained and processed as follows.

// obtaining output indicative of the userAgent

var ua=navigator.userAgent;

// using an analysis, such as a regular expression analysis, an indication of the title of the version of the browser can be detected.

if (ua.search(/Chrome/)>0) return ‘Google Chrome’;

if (ua.search(/Firefox/)>0) return ‘Firefox’;

if (ua.search(/Opera/)>0) return ‘Opera’;

if (ua.search(/Safari/)>0) return ‘Safari’;

if (ua.search(/MSIE/)>0) return ‘Yandex Browser’;

Naturally, any given analyses can have more or fewer conditions present therein.

Other examples of the computer executable code include but are not limited to:

var browser=get_name_browser( );

alert(browser);

In yet further embodiments of the present technology, the computer executable code can rely on the fact that in Javascript™ execution is forbidden if the browser is not in the provisioned list. Below, is an example list of computer executable commands that can be used for the specific browsers. It is noted that in order for these examples to work as the computer generated code as contemplated by various embodiments of the present technology, certain conditions need to be considered. Within embodiments of the present technology, the variable assignment is represented as an abbreviation of the browser (e.g. FF, IE, Op, Saf, Chr, etc.)

Furthermore, it is important that the detection shouldn't be able to be overwritten (e.g. IE=!!top.execScript is incorrect because a web site can redefine execScript as a variable or function).

Firefox™ browser detector

FF=/a/[−1]==‘a’

IE™ browser detector

IE=‘\v’==‘v’

Safari™ browser detector

Saf=/a/._proto_==‘//’

Chrome™ browser detector

Chr=/source/.test((/a/.toString+”))

Opera™ browser detector

Op=/̂function\(/.test([].sort)

IE6™ browser detector (using conditionals)

try {IE6=@cc_on@_jscript_version<=5.7&&@_jscript_build<10000}

In alternative embodiments of the present technology, the computer executable code can include Cascading Style Sheet (CSS) selectors. Generally speaking, a CSS Browser Selector is a small Javascript™ code with just one line which triggers CSS selectors. The CSS Browser Selector provides an ability to write specific CSS code for each operating system and/or each browser. CSS Selector can be implemented as a CSS rule, which specifies to the browser to which web-page element(s) to apply specific rules.

Chrome™ browser (and other WEBKIT engine—based web browsers)

WebKit (Chrome™ browser\Yandex™ browser)

.selector:not(*:root){}

Firefox™ browser

body:empty .selector{}

IE™ browser\EDGE™ browser

* html .selector {}

.unused-class.selector {}

As another example for IE™ browser:

head: {

‘document.getElementsByTagName(“head”)[0].nodeName.length’, //“HEAD”
value: 4
}.

Authentication Routine

Having described the authentication provisioning routine, having established how the static token 140 and the dynamic token 160 are created and stored by the electronic device 102, and having described the computer executable code generation routine, we will now turn our attention to the authentication routine, where the static token 140 and the dynamic token 160 are used to authorize access of the electronic device to the network resource 110.

When the application 108 requires access to the network resource 110, the application 108 sends an application access request 162 to the network resource server 109. For the sake of illustration, it shall be assumed that application 108 requires map data stored by the network resource 110 for incorporation thereof into the destination network resource 114. In some embodiments of the present technology, the application access request 162 contains an indication of log in credentials from the static token 140.

In other embodiments of the present technology, the network resource server 109 requests the log in credentials from the electronic device 102 in response to receiving the application access request 162 by transmitting a log in credential request (not depicted in FIG. 1).

It shall also be assumed that the application access request 162 includes a unique identifier of the electronic device in order to locate a specific record of the authentication data table 170. Alternatively, the network resource server 109 can request the indication of the unique identifier of the electronic device 102 from the electronic device 102 as part of the log in credential request or a separate request.

In response to the receipt of the log in credentials, the network resource server 109 locates the appropriate record within the authentication data table 170, based for example on the unique device identifier contained in the application access request 162. The network resource server 109 identifies the appropriate record by the unique device identifier 306 field of the authentication data table 170. Within instant example, the network resource server 109 identifies the first entry 302. The network resource server 109 then compares the received user credentials with the entry of the indication of authentication credentials 310. If the network resource server 109 determines a mismatch—the authentication routine terminates as the user credentials are not authenticated (i.e. the static token 140 is not validated).

If on the other hand the network resource server 109 determines the match, the network resource server 109 proceeds to attempt to validate the dynamic token 160. It should be recalled that there are two embodiments of how the dynamic token 160 can be generated with the computer-executable code. The computer executable code could have been pre-generated and stored within the dynamic token 160 or can be generated in real-time in response to the receipt of application access request 162 and/or in response to the receipt of the successful validation of the static token 140.

Starting with those embodiments, where the computer executable code has been pre-generated and stored within the dynamic token 160. The network resource server 109 triggers the dynamic token 160 to execute the computer executable code and to return to the network resource server 109 an execution output of the computer executable code. In some embodiments of the present technology, the network resource server 109 transmits an execution trigger 164 to the electronic device, the execution trigger 164 being configured to trigger the dynamic token 160 to execute the computer executable code and to generate the execution output for transmission thereof to the network resource server 109.

In those embodiments, where the computer executable code is generated in real-time in response to the receipt of application access request 162 and/or in response to the receipt of the successful validation of the static token 140, the network resource server 109 generates the computer executable code in response to receiving the log in credentials from the static token 140 and/or successful validation of the log in credentials of the static token 140. In some embodiments of the present technology, the so-generated computer executable code is at least partially based on the information contained in the static token 140. In some embodiments of the present technology, the so-generated computer executable code contains randomly selected instructions based at least in part on the information stores in the indication of the device-execution environment 308 associated with the electronic device 102.

The network resource server 109 then transmits the computer executable code to the electronic device—the transmission can trigger the dynamic token 160 to execute the computer executable code and to return to the network resource server 109 an execution output of the computer executable code.

In some embodiments of the present technology, the network resource server 109, additionally, transmits the execution trigger 164 to the electronic device, the execution trigger 164 being configured to trigger the dynamic token 160 to execute the computer executable code and to generate the execution output for transmission thereof to the network resource server 109.

In response to the receipt of the so-generated computer executable code or the execution trigger 164, the electronic device 102 executes the computer executable code to generate the execution output. The electronic device 102 then transmits the execution output to the network resource server 109, depicted in FIG. 1 as an execution output validation packet 166.

The network resource server 109 receives the execution output validation packet 166 and compares the so-received execution output to a pre-define expected execution output (recalling that the so-generated computer executable code is configured to solicit an execution output unique to the device-execution environment associated with the electronic device 102 being authenticated).

If the received execution output matches the pre-defined execution output that is unique to the device-execution environment, the dynamic token 160 is considered validated. In response to both the static token 140 and the dynamic token 160 being validated, the network resource server 109 authenticates the electronic device 102 and permits accessing the network resource 110 (or, more broadly, execution of the application).

Given the architecture described above, it is possible to execute a method of authorizing execution of an application on the electronic device 102. As has been alluded to above, authorizing execution of the application 108 can include authorizing access to a network resource, such as the network resource 110. In other words, the application 108 can be either a locally-executed application 108 or a web session with the network resource 110.

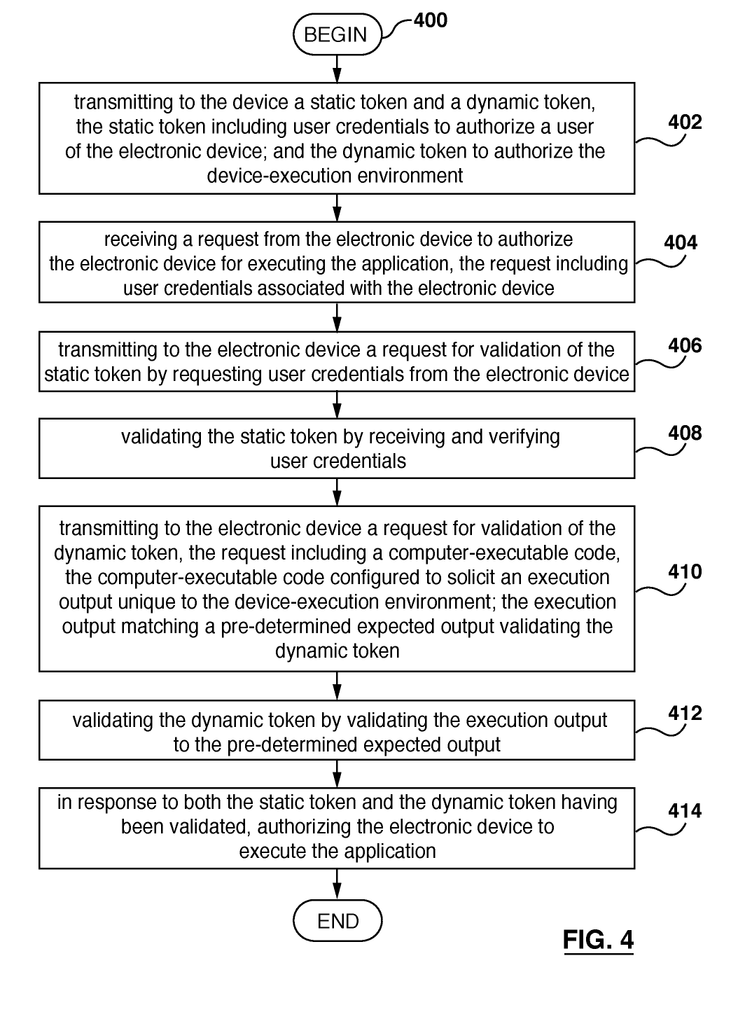

With reference to FIG. 4, there is depicted a block diagram of a method 400, the method 400 being implemented in accordance with non-limiting embodiments of the present technology. In some embodiments, the method 400 can be executed by the network resource server 109. In other embodiments of the present technology, the method 400 can be executed by a dedicated authentication server (not depicted), which can be separate from the network resource server 109 and the other network resource server 112.

Step 402—transmitting to the electronic device a static token and a dynamic token, the static token including user credentials to authorize the electronic device; and the dynamic token to authorize the device-execution environment

The method 400 begins at step 402, where the network resource server 109 transmits to the electronic device 102 a static token 140 and a dynamic token 160, the static token 140 including user credentials to authorize the electronic device 102 (or, alternatively, the user of the electronic device 102); and the dynamic token 160 to authorize the device-execution environment of the electronic device 102.

In some embodiments of the method 400, the device-execution environment comprises at least one of: a hardware parameter, an operating system parameter, and a software parameter and wherein the execution output is unique to at least one of the hardware parameter, the operating system parameter, and the software parameter. In some of these embodiments of the method 400, the execution output is unique to all of the hardware parameter, the operating system parameter, and the software parameter.

In some embodiments of the method 400, the method 400 further comprises generating the computer executable code. The generating the computer executable code comprises selecting a sub-set of computer-executable instructions from a set of computer-executable instructions, the set of computer-executable instructions having been pre-selected for the device-execution environment. How and when the computer-executable code can be generated was explained in detail herein above.

Step 404—receiving a request from the electronic device to authorize the electronic device for executing the application, the request including user credentials associated with the electronic device

At step 404, the network resource server 109 receives a request from the electronic device 102 to authorize the electronic device for executing the application 108, the request including user credentials associated with the electronic device 102.

As has been alluded to above, the user credentials can be implemented using any combination of the known user credential techniques.

Step 406—transmitting to the electronic device a request for validation of the static token by requesting user credentials from the device

At step 406, the network resource server 109 transmits to the electronic device 102 a request for validation of the static token 140 by requesting user credentials from the electronic device 102.

Step 408—validating the static token by receiving and verifying user credentials

At step 408, the network resource server 109 validates the static token 140 by receiving and verifying user credentials.

In some embodiments of the method 400, the generating the computer executable code is done before transmitting to the electronic device 102 the static token 140 and the dynamic token 160. In some of these embodiments of the method 400, the method 400 further comprises embedding the computer executable code into the dynamic token 160.

In some embodiments of the method 400, the generating the computer executable code is done in response to one of: the receiving the request to authorize the electronic device 102 for executing the application 108 and the validating of the static token 140.

In some embodiments of the method 400, the generating the computer executable code is based at least in part on the static token 140.

Step 410—transmitting to the electronic device a request for validation of the dynamic token, the request including a computer-executable code, the computer-executable code configured to solicit an execution output unique to the device-execution environment; the execution output matching a pre-determined expected output validating the dynamic token

At step 410, the network resource server 109 transmits to the electronic device 102 a request for validation of the dynamic token 160, the request including a computer-executable code, the computer-executable code configured to solicit an execution output unique to the device-execution environment; the execution output matching a pre-determined expected output validating the dynamic token 160.

Step 412—validating the dynamic token by validating the execution output to the pre-determined expected output

At step 412, the network resource server 109 validates the dynamic token 160 by validating the execution output to the pre-determined expected output.

Step 414—in response to both the static token and the dynamic token having been validated, authorizing the electronic device to execute the application

At step 414, the network resource server 109, in response to both the static token 140 and the dynamic token 160 having been validated, authorizing the electronic device 120 to execute the application 108.

In some embodiments of the present technology, authorization to execute the application 108 comprises an authorization to access the network resource 110 hosted by the network resource server 109 via the application 108.

In some embodiments of the method 400, the method further comprises transmitting an execution trigger (not depicted) to the electronic device 102, the execution trigger for triggering execution of the application 108 by the electronic device 102.

In some embodiments of the method 400, the generating the computer-executable code comprises selecting at least two sub-sets of computer-executable instructions from a set of computer-executable instructions, the set of computer-executable instructions having been pre-selected for the device-execution environment, each of the at least two sub-sets of computer-executable instructions for authorizing a particular execution portion of the application 108.

In some embodiments of the method 400, the application 108 is a web-session based application 108 that requires API data downloadable from the network resource server 109.

In some embodiments of the present technology, the method 400 then terminates.

Method 400 has been described using the example of the network resource 110 being the downloadable map for incorporating the map data into the destination network resource 114 hosted by the other network resource server 112. As has been described above, the network resource server 109 can generate the downloadable map as the JAVASCRIPT™ map for downloading via an Application Programming Interface (API) 116 hosted by the network resource server 109.

It should be however understood that embodiments of the present technology are not so limited. As such, embodiments of the present technology can be implemented for authentication access to other types of resources (local or networked), as well as for authorizing execution of an application, in general.

Given the architecture described above, it is possible to execute a method of authorizing execution of an application 108 on the electronic device 102 in accordance with another embodiment of the present technology. As has been alluded to above, authorizing execution of the application 108 can include authorizing access to a network resource, such as the network resource 110.

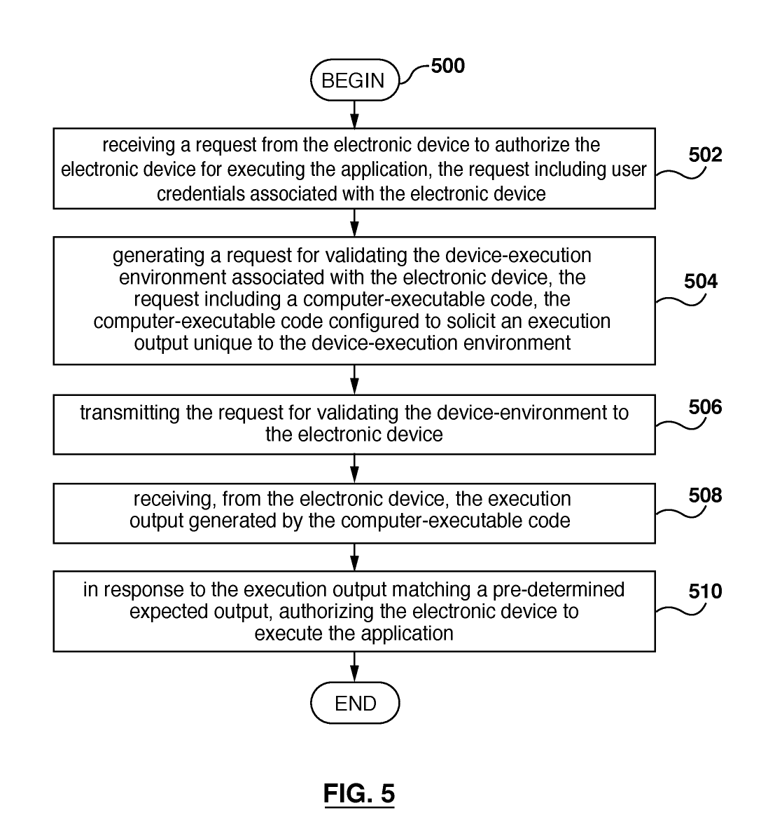

With reference to FIG. 5, there is depicted a block diagram of a method 500, the method 500 being implemented in accordance with non-limiting other embodiments of the present technology. In some embodiments, the method 500 can be executed by the network resource server 109. In other embodiments of the present technology, the method 500 can be executed by a dedicated authentication server (not depicted), which can be separate from the network resource server 109 and the other network resource server 112.

Step 502—receiving a request from the electronic device to authorize the electronic device for executing the application, the request including user credentials associated with the electronic device

The method 500 begins at step 502, where the network resource server 109 receives a request 162 from the electronic device 102 to authorize the electronic device 102 for executing the application 108, the request including user credentials associated with the electronic device 102 (or, alternatively, with the user of the electronic device 102).

Step 504—generating a request for validating the device-execution environment associated with the electronic device, the request including a computer-executable code, the computer-executable code configured to solicit an execution output unique to the device-execution environment

At step 504, the network resource server 109 generates a request for validating the device-execution environment associated with the electronic device 102, the request including a computer-executable code, the computer-executable code configured to solicit an execution output unique to the device-execution environment.

In some embodiments of the present technology, step 504 (and subsequent steps thereto) are in executed in response to a positive validation of the user credentials by the network resource server 109.

Step 506—transmitting the request for validating the device-execution environment to the electronic device

At step 506, the network resource server 109 transmits the request for validating the device-execution environment to the electronic device 102.

Step 508—receiving, from the electronic device, the execution output generated by the computer-executable code; in response to the execution output matching a pre-determined expected output, authorizing the electronic device to execute the application

At step 508, the network resource server 109 receives, from the electronic device 102, the execution output generated by the computer-executable code.

Step 510—in response to the execution output matching a pre-determined expected output, authorizing the electronic device to execute the application

At step 510, the network resource server 109, in response to the execution output matching a pre-determined expected output, authorizes the electronic device 102 to execute the application 108.

In some embodiments of the present technology, authorization to execute the application 108 comprises an authorization to access the network resource 110 hosted by the network resource server 109 via the application 108.

In some embodiments of the method 500, the method 500 further comprises an execution trigger 164 to the electronic device 102, the execution trigger for triggering execution of the application by the electronic device 102.

In some embodiments of the method 500, the device-execution environment comprises at least one of: a hardware parameter, an operating system parameter, and a software parameter and wherein the execution output is unique to at least one of the hardware parameter, the operating system parameter, and the software parameter. In some of these embodiments of the method 500, the execution output is unique to all of the hardware parameter, the operating system parameter, and the software parameter.

In some embodiments of the method 500, the method 500 further comprises generating the computer executable code.

In some embodiments of the method 500, the generating the computer executable code comprises selecting a sub-set of computer-executable instructions from a set of computer-executable instructions, the set of computer-executable instructions having been pre-selected for the device-execution environment.

In some embodiments of the method 500, the generating the computer executable code is done before the receiving 502 the request 162 to authorize the electronic device 102 for executing the application 108. In other embodiments of the method 500, the generating the computer executable code is done in response to one of: the receiving the request to authorize the electronic device 102 for executing the application 108 and the positive validation of the user credentials.

In some embodiments of the method 500, the generating the computer executable code is based at least in part on the user credentials.

In some embodiments of the method 500, the generating the computer-executable code comprises selecting at least two sub-sets of computer-executable instructions from a set of computer-executable instructions, the set of computer-executable instructions having been pre-selected for the device-execution environment, each of the at least two sub-sets of computer-executable instructions for authorizing a particular execution portion of the application 108.

In some embodiments of the method 500, the application is a web-session based application that requires API data downloadable from the network resource server 109.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method for authorizing execution of an application on an electronic device, the electronic device being connectable to a server via a communication network, the electronic device being associated with a device-execution environment, the method executable at a server, the method comprising:
transmitting to the electronic device a static token and a dynamic token, the static token including user credentials to authorize the electronic device; and the dynamic token to authorize the device-execution environment;
receiving a request from the electronic device to authorize the electronic device for executing the application, the request including user credentials associated with the electronic device;
transmitting to the electronic device a request for validation of the static token by requesting user credentials from the electronic device;
validating the static token by receiving and verifying user credentials;
transmitting to the electronic device a request for validation of the dynamic token, the request including a computer-executable code, the computer-executable code configured to solicit an execution output unique to the device-execution environment; the execution output matching a pre-determined expected output validating the dynamic token;
validating the dynamic token by validating the execution output to the pre-determined expected output; and
in response to both the static token and the dynamic token having been validated, authorizing the electronic device to execute the application.

2. The method of claim 1, further comprising transmitting an execution trigger to the electronic device, the execution trigger for triggering execution of the application by the electronic device.

3. The method of claim 1, wherein the device-execution environment comprises at least one of:
a hardware parameter, an operating system parameter, and a software parameter and wherein the execution output is unique to at least one of the hardware parameter, the operating system parameter, and the software parameter.

4. The method of claim 3, wherein the execution output is unique to all of the hardware parameter, the operating system parameter, and the software parameter.

5. The method of claim 1, further comprising generating the computer executable code.

6. The method of claim 5, wherein the generating the computer executable code comprises selecting a sub-set of computer-executable instructions from a set of computer-executable instructions, the set of computer-executable instructions having been pre-selected for the device-execution environment.

7. The method of claim 5, wherein the generating the computer executable code is done before transmitting to the electronic device the static token and the dynamic token.

8. The method of claim 7, further comprising embedding the computer executable code into the dynamic token.

9. The method of claim 5, wherein the generating the computer executable code is done in response to one of: the receiving the request to authorize the electronic device for executing the application and the validating of the static token.

10. The method of claim 9, wherein the generating the computer executable code is based at least in part on the static token.

11. The method of claim 1, wherein the generating the computer-executable code comprises selecting at least two sub-sets of computer-executable instructions from a set of computer-executable instructions, the set of computer-executable instructions having been pre-selected for the device-execution environment, each of the at least two sub-sets of computer-executable instructions for authorizing a particular execution portion of the application.

12. The method of claim 1, wherein the application is a web-session based application that requires API data downloadable from the server.

13. A method for authorizing execution of an application on an electronic device, the electronic device being connectable to a server via a communication network, the electronic device being associated with a device-execution environment, the method executable at a server, the method comprising:
receiving a request from the electronic device to authorize the electronic device for executing the application, the request including user credentials associated with the electronic device;
in response to positive validation of the user credentials:
generating a request for validating the device-execution environment associated with the electronic device, the request including a computer-executable code, the computer-executable code configured to solicit an execution output unique to the device-execution environment;
transmitting the request for validating the device-execution environment to the electronic device;
receiving, from the electronic device, the execution output generated by the computer-executable code;
in response to the execution output matching a pre-determined expected execution output, authorizing the electronic device to execute the application.

14. The method of claim 13, further comprising transmitting an execution trigger to the electronic device, the execution trigger for triggering execution of the application by the electronic device.

15. The method of claim 13, wherein the device-execution environment comprises at least one of: a hardware parameter, an operating system parameter, and a software parameter and wherein the execution output is unique to at least one of the hardware parameter, the operating system parameter, and the software parameter.

16. The method of claim 15, wherein the execution output is unique to all of the hardware parameter, the operating system parameter, and the software parameter.

17. The method of claim 13, further comprising generating the computer executable code.

18. The method of claim 17, wherein the generating the computer executable code comprises selecting a sub-set of computer-executable instructions from a set of computer-executable instructions, the set of computer-executable instructions having been pre-selected for the device-execution environment.

19. The method of claim 17, wherein the generating the computer executable code is done in response to one of: the receiving the request to authorize the electronic device for executing the application and the positive validation of the user credentials.

20. The method of claim 13 wherein the generating the computer-executable code comprises selecting at least two sub-sets of computer-executable instructions from a set of computer-executable instructions, the set of computer-executable instructions having been pre-selected for the device-execution environment, each of the at least two sub-sets of computer-executable instructions for authorizing a particular execution portion of the application.
